(19) United States
(12) Patent Application Publication
(10) Pub. No.: US 2022/0138832 A1
(43) Pub. Date: May 5, 2022

(54) INFORMATION PROCESSING APPARATUS, INFORMATION PROCESSING METHOD, AND SYSTEM

(71) Applicant: TOYOTA JIDOSHA KABUSHIKI KAISHA, Toyota-shi (JP)

(72) Inventors: Jun Usami, Toyota-shi (JP); Takaharu Ueno, Nagoya-shi (JP); Shunsuke Sagara, Nisshin-shi (JP); Lei Wang, Toyota-shi (JP); Shintaro Matsutani, Kariya-shi (JP); Kyoji Iijima, Toyota-shi (JP)

(73) Assignee: TOYOTA JIDOSHA KABUSHIKI KAISHA, Toyota-shi (JP)

(21) Appl. No.: 17/514,174

(22) Filed: Oct. 29, 2021

(30) Foreign Application Priority Data
Nov. 2, 2020 (JP) 2020-183895

(51) Int. Cl. G06Q 30/06; G01S 19/01; G06K 9/00; H04N 7/18

(52) U.S. Cl. CPC G06Q 30/0631; G01S 19/01; H04W 84/12; H04N 7/18; G06K 9/00771

(57) ABSTRACT

A controller is provided that is configured to perform: obtaining information about shoes worn by a user when the user goes out; obtaining a moving distance on foot when the user goes out; managing the moving distance on foot in association with the shoes worn by the user when the user goes out; and proposing, to the user, replacement of the shoes worn by the user when an integrated value of the moving distance on foot associated with the shoes worn by the user when the user goes out is equal to or greater than a threshold value.

### CROSS REFERENCE TO THE RELATED APPLICATION

This application claims the benefit of Japanese Patent Application No. 2020-183895, filed on Nov. 2, 2020, which is hereby incorporated by reference herein in its entirety.

### BACKGROUND

### Technical Field

The present disclosure relates to an information processing apparatus, an information processing method, and a system.

### Description of the Related Art

There has been disclosed a technique in which data is obtained from a sensor incorporated in a shoe, so that shoes suitable for a user can be produced, or replacement of the shoe is predicted based on the data (for example, Patent Literature 1).

### CITATION LIST

### Patent Literature

Patent Literature 1: Japanese Patent Application Laid-Open Publication No. 2017-131630

### SUMMARY

An object of the present disclosure is to propose replacement of shoes to a user at an appropriate time.

One aspect of the present disclosure is directed to an information processing apparatus including a controller configured to perform:

obtaining information about shoes worn by a user when the user goes out;

obtaining a moving distance on foot when the user goes out;

managing the moving distance on foot in association with the shoes worn by the user when the user goes out; and

proposing, to the user, replacement of the shoes worn by the user at the time of going out, when an integrated value of the moving distance on foot associated with the shoes worn by the user at the time of going out is equal to or greater than a threshold value.

Another aspect of the present disclosure is directed to an information processing method for causing a computer to perform:

obtaining information about shoes worn by a user when the user goes out;

obtaining a moving distance on foot when the user goes out;

managing the moving distance on foot in association with the shoes worn by the user when the user goes out; and

proposing, to the user, replacement of the shoes worn by the user at the time of going out, when an integrated value of the moving distance on foot associated with the shoes worn by the user at the time of going out is equal to or greater than a threshold value.

A further aspect of the present disclosure is directed to a system comprising:

a camera provided at an entrance of a house of a user; and

a server;

wherein the server performs:

obtaining from the camera information about shoes worn by the user when the user goes out;

obtaining a moving distance on foot when the user goes out;

managing the moving distance on foot in association with the shoes worn by the user when the user goes out; and

proposing, to a terminal of the user, replacement of the shoes worn by the user at the time of going out, when an integrated value of the moving distance on foot associated with the shoes worn by the user at the time of going out is equal to or greater than a threshold value.

In addition, a still further aspect of the present disclosure is directed to a program causing a computer to perform the above-described method, or a storage medium storing the program in a non-transitory manner.

According to the present disclosure, it is possible to propose replacement of shoes to a user at an appropriate time.

### BRIEF DESCRIPTION OF THE DRAWINGS

FIG. 1 is a view illustrating a schematic configuration of a system according to an embodiment;

FIG. 2 is a block diagram schematically illustrating an example of a configuration of each of a camera, a user terminal and a server, which together constitute the system according to the embodiment;

FIG. 3 is a diagram illustrating an example of a functional configuration of the server;

FIG. 4 is a diagram illustrating an example of a table structure of a shoe information DB:

FIG. 5 is a diagram illustrating an example of a functional configuration of the user terminal;

FIG. 6 is a flowchart of processing in which the server proposes replacement of shoes to a user according to the embodiment;

FIG. 7 is a flowchart illustrating a flow of proposal processing; and

FIG. 8 is a flowchart of processing when the user terminal receives proposal information according to the present embodiment.

### DESCRIPTION OF THE EMBODIMENTS

Here, in cases where a sensor is attached to a shoe to predict the time when the shoe should be replaced, the shoe can be expensive because the sensor is attached to the shoe. In addition, since only shoes with sensors attached are supported, it is not possible to predict the time of replacement of shoes to which sensors are not attached. On the other hand, an information processing apparatus, which is one aspect of the present disclosure, proposes replacement of a shoe to a user at an appropriate time without attaching a sensor to the shoe.

The information processing apparatus, which is one aspect of the present disclosure, is provided with a controller. The controller obtains information on shoes worn by a user when the user goes out, obtains a distance traveled or moved on foot (hereinafter referred to as a moving distance on foot) when the user goes out, manages the moving distance on foot in association with the shoes worn by the user when the user goes out, and proposes, to the user, replacement of the shoes worn by the user at the time of going out, when an integrated value of the moving distance on foot associated with the shoes worn by the user at the time of going out is equal to or greater than a threshold value.

The information about the shoes worn by the user when the user goes out is, for example, information that can identify the shoes the user wears when going out. In cases where the user owns a plurality of pairs of shoes, it is possible to determine which pair of shoes the user wears to go out, based on the information about the shoes worn by the user when the user goes out. The information about the shoes worn by the user when the user goes out can include an image of the shoes the user wears when going out. For example, the image can be obtained from a camera provided at an entrance of a house of the user. This camera takes pictures or images of, for example, an area around the entrance of the user's house.

In addition, the moving distance on foot when the user goes out can be obtained based on, for example, position information of a terminal carried by the user. For example, it is possible to determine whether or not the user is moving on foot based on the temporal transition of the position information. Also, for example, the moving distance of the user can be obtained based on the temporal transition of the position information.

Moreover, the controller manages the moving distance on foot in association with the shoes worn by the user when the user goes out. For example, the distance the user has moved on foot while wearing the shoes is integrated, and the value thus integrated is stored. This integrated value is the distance that the shoes have been used to move on foot, and correlates with the degree of deterioration of the shoes. Therefore, it is possible to know the degree of deterioration of the shoes based on the moving distance on foot that is managed by the controller.

Then, when the integrated value of the moving distance on foot associated with the shoes worn by the user at the time of going out becomes equal to or greater than the threshold value, the controller proposes, to the user, replacement of the shoes worn by the user at the time of going out. The threshold value is a moving distance for which replacement of the shoes is proposed, and may also be a moving distance for which the shoes deteriorate to such an extent that replacement of the shoes is necessary. In this way, it is possible to propose replacement of the shoes to the user at an appropriate time, by proposing the replacement of the shoes to the user when the integrated value of the moving distance on foot becomes equal to or greater than the threshold value.

Hereinafter, embodiments of the present disclosure will be described based on the accompanying drawings. The configurations of the following embodiments are examples, and the present disclosure is not limited to the configurations of the embodiments. In addition, the following embodiments can be combined with one another as long as such combinations are possible and appropriate.

### First Embodiment

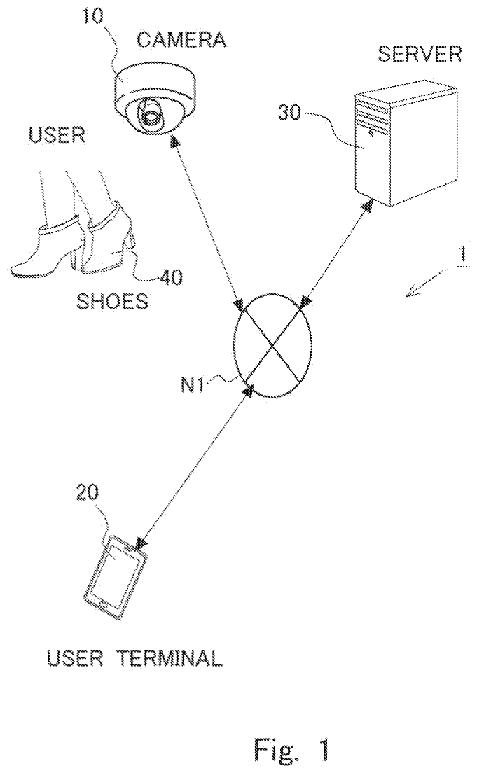

FIG. 1 is a view illustrating a schematic configuration of a system 1 according to a first embodiment of the present disclosure. In the example of FIG. 1, the system 1 includes a camera 10 disposed at an entrance of a user's home, a user terminal 20, and a server 30. The camera 10 is disposed at a position where the shoes 40 worn by a user can be photographed when the user goes out. The camera 10 transmits the image thus photographed to the server 30. The user terminal 20 is a terminal that is used by the user. The user is a user who receives a service regarding a proposal for replacement of the shoes 40. The user terminal 20 is a terminal that receives the proposal for replacement of the shoes 40 from the server 30. Also, the user terminal 20 is a terminal that transmits position information to the server 30.

The server 30 obtains images from the camera 10. The server 30 analyzes the images taken by the camera 10 to identify the shoes worn by the user when the user goes out. The server 30 integrates and stores the distance moved by the user on foot for each shoe 40.

The camera 10, the user terminal 20, and the server 30 are connected to one another by a network N1. The network N1 is, for example, a worldwide public communication network such as the Internet, and a WAN (Wide Area Network) or other communication networks may be adopted. Also, the network N1 may include a telephone communication network such as a mobile phone network or the like, or a wireless communication network such as Wi-Fi (registered trademark) or the like. Note that one camera 10, one user terminal 20 and one pair of shoes 40 are illustrated in FIG. 1 by way of example, but there can be a plurality of cameras 10, a plurality of user terminals 20, and a plurality of pairs of shoes 40.

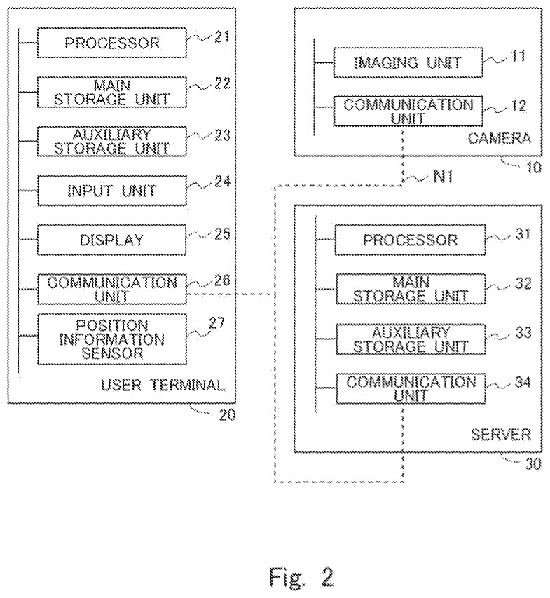

Hardware configurations and functional configurations of the camera 10, the user terminal 20 and the server 30 will be described based on FIG. 2. FIG. 2 is a block diagram schematically illustrating one example of the configuration of each of the camera 10, the user terminal 20 and the server 30, which together constitute the system 1 according to the present embodiment.

The server 30 has a configuration of a general computer. The server 30 includes a processor 31, a main storage unit 32, an auxiliary storage unit 33, and a communication unit 34. These components are connected to one another by means of a bus. The processor 31 is an example of a controller. The main storage unit 32 or the auxiliary storage unit 33 is an example of a memory.

The processor 31 is a CPU (Central Processing Unit), a DSP (Digital Signal Processor), or the like. The processor 31 controls the server 30 thereby to perform various information processing operations. The main storage unit 32 is a RAM (Random Access Memory), a ROM (Read Only Memory), or the like. The auxiliary storage unit 33 is an EPROM (Erasable Programmable ROM), a hard disk drive (HDD), a removable medium, or the like. The auxiliary storage unit 33 stores an operating system (OS), various programs, various tables, and the like. The processor 31 loads the programs stored in the auxiliary storage unit 33 into a work area of the main storage unit 32 and executes the programs, so that each of the component units or the like is controlled through the execution of the programs. As a result, the server 30 realizes functions that match predetermined purposes. The main storage unit 32 and the auxiliary storage unit 33 are computer readable recording media. Here, note that the server 30 may be a single computer or a plurality of computers that cooperate with one another. In addition, the information stored in the auxiliary storage unit 33 may be stored in the main storage unit 32. Also, the information stored in the main storage unit 32 may be stored in the auxiliary storage unit 33.

The communication unit 34 is a means or unit that communicates with the user terminal 20 via the network N1. The communication unit 34 is, for example, a LAN (Local Area Network) interface board, a wireless communication circuit for wireless communication, or the like. The LAN interface board or the wireless communication circuit is connected to the network N1.

Then, the camera 10 is a device that is disposed in the vicinity of the entrance of the user's house to take pictures of an area around the camera 10. The camera 10 may be located either indoors or outdoors, as long as it is in a position where it can take pictures of the shoes worn by the user. The camera 10 is provided with an imaging unit 11 and a communication unit 12. The imaging unit 11 takes pictures by using an imaging element such as a CCD (Charge Coupled Device) image sensor, a CMOS (Complementary Metal Oxide Semiconductor) image sensor or the like. The images obtained by taking pictures may be either still images or moving images.

The communication unit 12 is a communication means or unit for connecting the camera 10 to the network N1. The communication unit 12 is, for example, a circuit for communicating with other devices (e.g., the server 30 or the like) via the network N1 by making use of a mobile communication service (e.g., a telephone communication network such as 5G (5th Generation), 4G (4th Generation), 3G (3rd Generation), LTE (Long Term Evolution) or the like), or a wireless communication such as Wi-Fi (registered trademark), Bluetooth (registered trademark) or the like. The images taken by the camera 10 are transmitted to the server 30 through the communication unit 12.

Next, the user terminal 20 will be described. The user terminal 20 is, for example, a smart phone, a mobile phone, a tablet terminal, a personal information terminal, a wearable computer (such as a smart watch or the like), or a small computer such as a personal computer (PC). The user terminal 20 includes a processor 21, a main storage unit 22, an auxiliary storage unit 23, an input unit 24, a display 25, a communication unit 26, and a position information sensor 27. These components are connected to one another by means of a bus. The processor 21, the main storage unit 22 and the auxiliary storage unit 23 are the same as the processor 31, the main storage unit 32 and the auxiliary storage unit 33 of the server 30, respectively, and hence, the description thereof will be omitted.

The input unit 24 is a means or unit that receives an input operation performed by the user, and is, for example, a touch panel, a mouse, a keyboard, a push button, or the like. The display 25 is a means or unit that presents information to the user, and is, for example, an LCD (Liquid Crystal Display), an EL (Electroluminescence) panel, or the like. The input unit 24 and the display 25 may be configured as a single touch panel display.

The communication unit 26 is a communication means or unit for connecting the user terminal 20 to the network N1. The communication unit 26 is, for example, a circuit for communicating with other devices (e.g., the user terminal 20, the server 30 or the like) via the network N1 by making use of a mobile communication service (e.g., a telephone communication network such as 5G (5th Generation), 4G (4th Generation), 3G (3rd Generation), LTE (Long Term Evolution) or the like), or a wireless communication network such as Wi-Fi (registered trademark), Bluetooth (registered trademark) or the like.

The position information sensor 27 obtains position information (e.g., latitude and longitude) of the user terminal 20 at predetermined intervals. The position information sensor 27 is, for example, a GPS (Global Positioning System) receiver unit, a wireless communication unit or the like. The information obtained by the position information sensor 27 is recorded, for example, in the auxiliary storage unit 23 or the like and transmitted to the server 30.

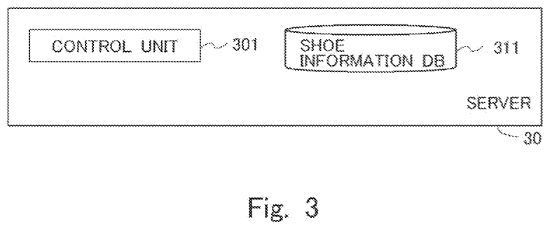

Now, the functions of the server 30 will be described. FIG. 3 is a view illustrating an example of a functional configuration of the server 30. The server 30 includes a control unit 301 and a shoe information DB 311 as functional components. The processor 31 of the server 30 executes the processing of the control unit 301 by a computer program on the main storage unit 32. The shoe information DB 311 is constructed by a program of a database management system (DBMS) that is executed by the processor 31 to manage data stored in the auxiliary storage unit 33. The shoe information DB 311 is, for example, a relational database. Here, note that any of the individual functional components of the server 30 or a part of the processing thereof may be executed by another computer connected to the network N1.

The control unit 301 determines based on the images received from the camera 10 that the user has gone out. For example, the control unit 301 determines based on the images that the user has worn the shoes 40 or that the user has left the entrance to the outside, and then determines that the user has gone out, when these actions are performed. Alternatively, the control unit 301 may determine that the user has gone out, based on the position information received from the user terminal 20. For example, when the position of the user terminal 20 moves from indoors to outdoors, it may be determined that the user has gone out.

Further, the control unit 301 identifies, based on the images received from the camera 10, the shoes 40 that the user is wearing when the user goes out. For example, the control unit 301 identifies the shoes 40 by comparing the feature amounts of the images with the information stored in the shoe information DB 311 to be described later. Here, note that when there is no information about the shoes 40 corresponding to the information stored in the shoe information DB 311, the control unit 301 determines that the shoes 40 are a new pair of shoes 40, and registers the new shoes 40 in the shoe information DB 311.

In addition, the control unit 301 also determines that the user has returned home, based on the images received from the camera 10. For example, the control unit 301 determines based on the images that the user has taken off the shoes 40, or that the user has entered the house from the entrance, and then determines that the user has returned home when these actions have occurred. Alternatively, the control unit 301 may determine that the user has returned home, based on the position information received from the user terminal 20. For example, when the position of the user terminal 20 moves from outdoors to indoors, it may be determined that the user has returned home.

Moreover, the control unit 301 calculates the distance the user has traveled or moved on foot. For example, an amount of movement per unit time, or a moving speed of the user, is calculated based on the position information received from the user terminal 20 at predetermined intervals. Then, when the moving speed of the user is within a predetermined range in which the user is considered to be moving on foot, it is determined that the user is moving on foot. The predetermined range referred to herein is, for example, a range of the moving speed lower than a moving speed by a moving means other than walking such as a bicycle, a car, a train, an airplane, a ship or the like. Here, in cases where the user is moving by a moving means other than walking, for example by a bicycle, a car, a train, an airplane, a ship or the like, the shoes 40 hardly deteriorate, and hence, the moving distance in the case where the user is moving by a moving means other than walking is not taken into consideration when determining the replacement of the shoes 40.

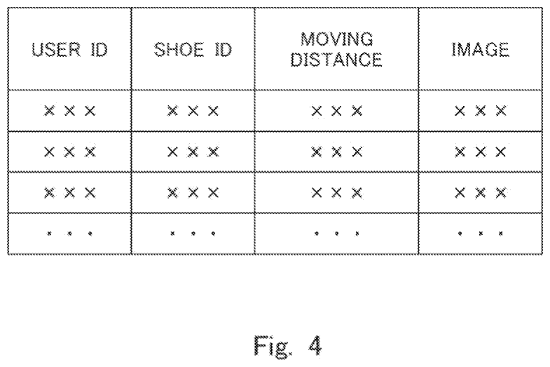

The control unit 301 integrates the moving distance on foot associated with the shoes 40 worn by the user when going out, and stores the moving distance thus integrated in the shoe information DB 311. Here, FIG. 4 is a diagram illustrating an example of a table structure of the shoe information DB 311. A shoe information table has fields of user ID, shoe ID, moving distance, and image.

The user ID field is a field in which identification information unique to a user is entered. The control unit 301 assigns a user ID to each user. Note that a user ID may be identification information unique to a user terminal 20 of each user. The user ID and the user terminal 20 of a user may be associated with each other. The shoe ID field is a field in which identification information unique to each shoe (or each pair of shoes) 40 is entered. The control unit 301 assigns a shoe ID to each shoe (or each pair of shoes) 40. The moving distance field is a field into which an integrated value of a moving distance on foot is entered. When a user wearing a pair of shoes 40 goes out, the control unit 301 searches for a corresponding record in the shoe information DB 311, and updates the moving distance field of the user by adding a moving distance of the user on foot to the moving distance stored in the corresponding moving distance field. As a result, the moving distance stored in the moving distance field of the user indicates the total distance traveled by the user on foot since the shoes 40 were new. The image field is a field in which information about an image of each shoe (or each pair of shoes) 40 is entered. The information about the image of a shoe (or a pair of shoes) 40 is, for example, the image of the shoe(s) 40, information indicating a place or location where the image of the shoe(s) 40 is stored, a feature amount of the image of the shoe(s) 40, or information indicating a place or location where the feature amount of the image of the shoe(s) 40 is stored.

Upon receiving the image from the camera 10, the control unit 301 analyzes the image, and identifies the shoes 40 worn by the user when the user goes out. Further, the control unit 301 receives position information from the user terminal 20 of the user while the user is out, and calculates a distance that the user is moving on foot. The moving distance thus calculated is added to the moving distance stored in the corresponding moving distance field of the shoe information DB 311 thereby to update the moving distance field. When the image of the shoes 40 received from the camera 10 does not match the image of the shoes 40 stored in the image field of the shoe information DB 311, the control unit 301 determines that the shoes 40 are new shoes 40, assigns a new shoe ID, generates a new record, and stores each piece of information.

Then, when the moving distance stored in the moving distance field reaches a predetermined distance which is a threshold value for replacing the shoes, the control unit 301 transmits information for proposing replacement of the shoes to the corresponding user terminal 20 together with information of the shoes 40. For example, information for displaying, on the display 25 of the user terminal 20, the image of the shoes 40 and a statement or phrase “it is time to replace them” is transmitted to the user terminal 20.

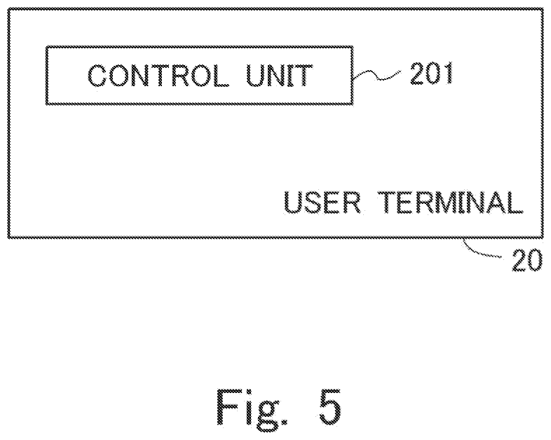

Next, the functions of the user terminal 20 will be described. FIG. 5 is a diagram illustrating an example of a functional configuration of the user terminal 20. The user terminal 20 includes a control unit 201 as its functional component. The processor 21 of the user terminal 20 executes the processing of the control unit 201 by a computer program on the main storage unit 22.

The control unit 201 transmits position information obtained from the position information sensor 27 to the server 30 at a predetermined interval. The predetermined interval is an interval at which it is possible to determine whether or not the user is moving on foot. In addition, upon receiving from the server 30 information about a proposal for replacement of the shoes 40, the control unit 201 provides a predetermined output to the display 25 according to the information. The control unit 201 displays, on the display 25 of the user terminal 20, for example, the image of the shoes 40 and the phrase “it is time to replace them”.

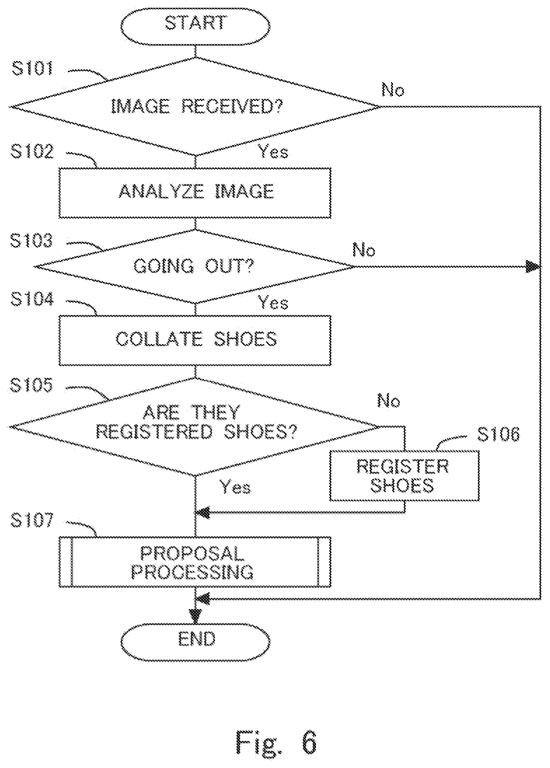

Then, a description will be made of processing in which the server 30 proposes replacement of the shoes 40 to the user. FIG. 6 is a flowchart of the processing in which the server 30 proposes replacement of the shoes 40 to the user according to the present embodiment. The routine illustrated in FIG. 6 is executed for each user.

In step S101, the control unit 301 determines whether or not an image has been received from the camera 10. When an affirmative determination is made in step S101, the processing proceeds to step S102, whereas when a negative determination is made, this routine is ended. In step S102, the control unit 301 analyzes the image thus received. In step S103, the control unit 301 determines, based on the analysis result of the image, whether or not a user is going out. The control unit 301 determines whether or not the user is going out, by comparing an image corresponding to an action of the user at the time of going out stored in the auxiliary storage unit 33 with the image received from the camera 10. Alternatively, in cases where it is found that the position of the user terminal 20 has moved from indoors to outdoors, based on position information received from the user terminal 20, it may be determined that the user is going out. When an affirmative determination is made in step S103, the processing proceeds to step S104, whereas when a negative determination is made, this routine is ended.

In step S104, the control unit 301 collates the shoes 40. The control unit 301 compares a feature amount of the image received with a feature amount of each image stored in the shoe information DB 311 thereby to collate the shoes 40. In step S105, the control unit 301 determines whether or not the shoes 40 worn by the user at the time of going out are a registered pair of shoes 40. In this step S105, the control unit 301 determines, as a result of collating the shoes 40 in step S104, whether or not there are a corresponding pair of shoes 40. When an affirmative determination is made in step S105, the processing proceeds to step S107, whereas when a negative determination is made, the processing proceeds to step S106.

In step S106, the control unit 301 registers a new pair of shoes 40 in the shoe information DB 311. The control unit 301 creates a new record in the shoe information DB 311, and stores information about the new shoes in each field of user ID, shoe ID, moving distance, and image. At this time, 0 is stored in the moving distance field.

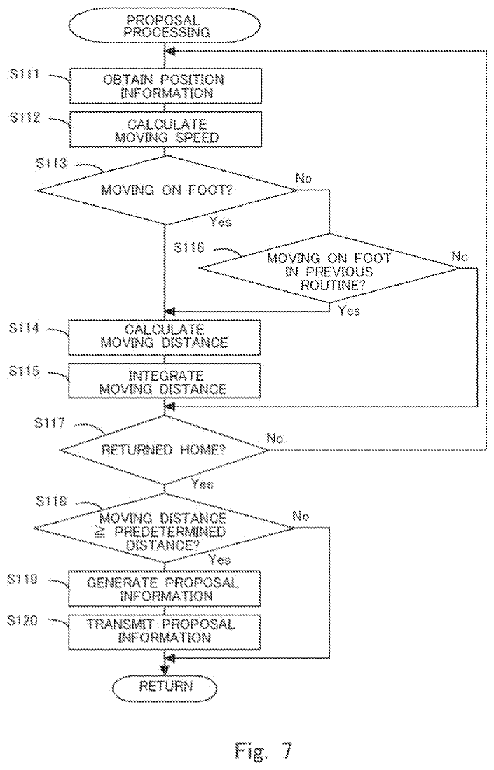

In step S107, the control unit 301 executes proposal processing. FIG. 7 is a flowchart illustrating a flow of the proposal processing.

In step S111, the control unit 301 obtains position information. The latest position information transmitted from the user terminal 20 is obtained as the position information. In step S112, the control unit 301 calculates a moving speed of the user terminal 20. The control unit 301 calculates the moving speed based on the position information obtained in the previous routine, the position information obtained in the current routine, and the cycle of calculation. In step S113, the control unit 301 determines whether or not the user is moving on foot. For example, when the moving speed of the user terminal 20 is within a predetermined range, the control unit 301 determines that the user is moving on foot. For example, when the position information of the user terminal 20 indicates a place where the user cannot move on foot (e.g., an expressway, a railroad, a river, or a sea), it may be determined that the user is not moving on foot. When an affirmative determination is made in step S113, the processing proceeds to step S114, whereas when a negative determination is made, the processing proceeds to step S116.

In step S114, the control unit 301 calculates a moving distance of the user terminal 20. The control unit 301 calculates the moving distance of the user terminal 20 from the previous routine to the current routine. In step S115, the control unit 301 integrates the moving distance corresponding to the shoes 40 worn by the user. The control unit 301 adds the value calculated in step S114 to the moving distance stored in the moving distance field of the shoe information DB 311. Then, the shoe information DB 311 is updated by storing the calculated value in the moving distance field. Note that, in this routine, the shoe information DB 311 is updated at each calculation cycle, but as another method, the distance traveled or moved by the user until the user returns home may be stored in the auxiliary storage unit 33, so that the shoe information DB 311 may be updated after the user returns home.

In step S116, the control unit 301 determines whether or not the user was moving on foot in the previous routine. In this step S11, it is determined whether or not the transportation means of the user has changed from walking to a means other than walking. When an affirmative determination is made in step S116, the processing proceeds to step S114, whereas when a negative determination is made, the processing proceeds to step S117 without integrating the moving distance. That is, in cases where the user was moving by means other than walking, integration of the moving distance is not performed, and the shoe information DB 311 is not updated.

In step S117, the control unit 301 determines whether or not the user has returned home. The control unit 301 determines that the user has returned home, for example, when the user terminal 20 is located at the user's home or when the position information of the user terminal 20 indicates that the user has moved from outdoors to indoors. Here, note that, as another method, the control unit 301 may determine whether or not the user has returned home, by analyzing the image received from the camera 10. For example, when the user is shown in the image received from the camera 10, it may be determined that the user has returned home. When an affirmative determination is made in step S117, the processing proceeds to step S118, whereas when a negative determination is made, the processing returns to step S111.

In step S118, the control unit 301 determines whether or not the moving distance of the user's shoes 40 stored in the shoe information DB 311 is equal to or greater than the predetermined distance. The predetermined distance has been stored in advance in the auxiliary storage unit 33 as a moving distance for which replacement of the shoes is proposed. The predetermined distance may be set by the user via the user terminal 20, or may be set by the control unit 301. When an affirmative determination is made in step S118, the processing proceeds to step S119, whereas when a negative determination is made, the processing of step S107 in FIG. 7 is ended by terminating this routine without proposing replacement of the shoes 40.

In step S119, the control unit 301 generates proposal information, which is information for proposing replacement of the shoes 40. The proposal information includes information for displaying on the display 25 of the user terminal 20 an image of the corresponding shoes 40 and a phrase or statement that prompts the user to replace the shoes 40. Then, in step S120, the control unit 301 transmits the proposal information to the user terminal 20. Thereafter, this routine ends, and thus the processing of step S107 in FIG. 7 is terminated.

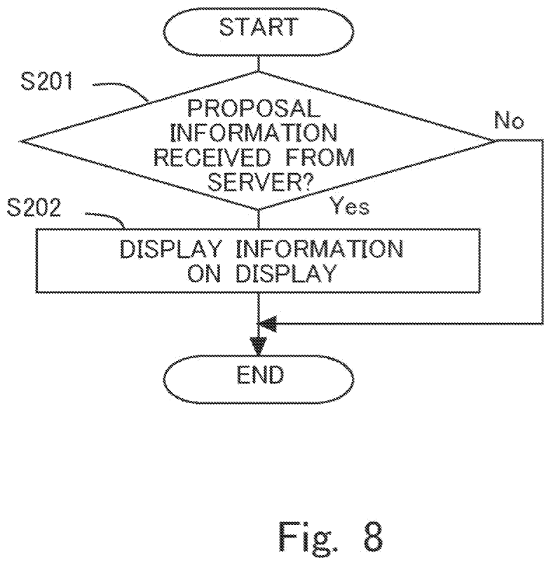

Next, FIG. 8 is a flowchart of processing when the user terminal 20 receives proposal information according to the present embodiment. The processing illustrated in FIG. 8 is executed at predetermined time intervals in the user terminal 20.

In step S201, the control unit 201 determines whether or not proposal information has been received from the server 30. When an affirmative determination is made in step S201, the processing or routine proceeds to step S202, whereas when a negative determination is made, this routine is ended. In step S202, the control unit 201 displays, for example, the image of the shoes 40 and the statement “It is time to replace them” on the display 25 in accordance with the proposal information received from the server 30.

As described above, according to the present embodiment, it is possible to determine, based on the image taken by the camera 10 and the position information of the user terminal 20, whether or not the shoes 40 worn by the user when going out have reached the end of their life. Then, when the shoes 40 have reached the end of their life, it is possible to propose replacement of the shoes 40 to the user. As a result, it is possible to propose replacement of the shoes 40 to the user at an appropriate time without attaching a sensor or the like to the shoes 40.

### Other Embodiments

The above-described embodiment is merely an example, but the present disclosure can be implemented with appropriate modifications without departing from the spirit thereof.

The processing and/or means (devices, units, etc.) described in the present disclosure can be freely combined and implemented as long as no technical contradiction occurs.

The processing described as being performed by one device or unit may be shared and performed by a plurality of devices or units. Alternatively, the processing described as being performed by different devices or units may be performed by one device or unit. In a computer system, a hardware configuration (server configuration) for realizing each function thereof can be changed in a flexible manner. For example, the camera 10 or the user terminal 20 may include all or a part of the functions of the server 30.

The present disclosure can also be realized by supplying to a computer a computer program in which the functions described in the above-described embodiment are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, or any type of medium suitable for storing electronic commands or instructions.

What is claimed is:

1. An information processing apparatus including a controller configured to perform;
obtaining information about shoes worn by a user when the user goes out;
obtaining a moving distance on foot when the user goes out;
managing the moving distance on foot in association with the shoes worn by the user when the user goes out; and
proposing, to the user, replacement of the shoes worn by the user at the time of going out, when an integrated value of the moving distance on foot associated with the shoes worn by the user at the time of going out is equal to or greater than a threshold value.

2. The information processing apparatus according to claim 1, wherein
the controller identifies, based on an image obtained when the user goes out, the shoes worn by the user when the user goes out.

3. The information processing apparatus according to claim 2, wherein
the controller obtains the image from a camera provided at an entrance of a house of the user.

4. The information processing apparatus according to claim 1, wherein
the controller obtains position information from a terminal of the user.

5. The information processing apparatus according to claim 4, wherein
the controller determines, based on the position information, whether or not the user is moving on foot.

6. The information processing apparatus according to claim 4, wherein
the controller calculates the moving distance on foot of the user based on a moving amount per unit time calculated based on the position information.

7. The information processing apparatus according to claim 4, further comprising;
a memory configured to store an integrated value of the moving distance on foot of the user obtained based on the position information in association with the shoes worn by the user when the user goes out.

8. The information processing apparatus according to claim 1, wherein
when proposing to the user to buy a new pair of shoes, the controller transmits information about a proposal to buy the new shoes to a terminal of the user.

9. An information processing method for causing a computer to perform;
obtaining information about shoes worn by a user when the user goes out;
obtaining a moving distance on foot when the user goes out;
managing the moving distance on foot in association with the shoes worn by the user when the user goes out; and
proposing, to the user, replacement of the shoes worn by the user at the time of going out, when an integrated value of the moving distance on foot associated with the shoes worn by the user at the time of going out is equal to or greater than a threshold value.

10. The information processing method according to claim 9, wherein
the computer identifies, based on an image obtained when the user goes out, the shoes worn by the user when the user goes out.

11. The information processing method according to claim 10, wherein
the computer obtains the image from a camera provided at an entrance of a house of the user.

12. The information processing method according to claim 9, wherein
the computer obtains position information from a terminal of the user.

13. The information processing method according to claim 12, wherein
the computer determines, based on the position information, whether or not the user is moving on foot.

14. The information processing method according to claim 12, wherein
the computer calculates the moving distance on foot of the user based on a moving amount per unit time calculated based on the position information.

15. The information processing method according to claim 12, wherein
the computer is further provided with a memory configured to store an integrated value of the moving distance on foot of the user obtained based on the position information in association with the shoes worn by the user when the user goes out.

16. The information processing method according to claim 9, wherein
when proposing to the user to buy a new pair of shoes, the computer transmits information about a proposal to buy the new shoes to a terminal of the user.

17. A system comprising;
a camera provided at an entrance of a house of a user; and
a server;
wherein the server is configured to perform;
obtaining from the camera information about shoes worn by the user when the user goes out;
obtaining a moving distance on foot when the user goes out;
managing the moving distance on foot in association with the shoes worn by the user when the user goes out; and
proposing, to a terminal of the user, replacement of the shoes worn by the user at the time of going out, when an integrated value of the moving distance on foot associated with the shoes worn by the user at the time of going out is equal to or greater than a threshold value.

18. The system according to claim 17, wherein
the server obtains position information from the terminal of the user.

19. The system according to claim 18, wherein
the server determines, based on the position information, whether or not the user is moving on foot.

20. The system according to claim 18, wherein
the server is further provided with a memory configured to store an integrated value of the moving distance on foot of the user obtained based on the position information in association with the shoes worn by the user when the user goes out.
